(19) United States
(12) Patent Application Publication
(10) Pub. No.: US 2011/0246731 A1
(43) Pub. Date: Oct. 6, 2011

(54) BACKUP SYSTEM AND BACKUP METHOD

(75) Inventors: Kenta Ninose, Yokohama (JP); Shunji Kawamura, Yokohama (JP)

(73) Assignee: Hitachi, Ltd.

(21) Appl. No.: 12/527,411

(22) PCT Filed: Mar. 18, 2009
(86) PCT No.: PCT/JP2009/056026

§ 371 Date: Aug. 14, 2009

(51) Int. Cl. G06F 12/16; G06F 12/02

(52) U.S. Cl. 711/162; 711/E12.103; 711/E12.002

(57) ABSTRACT

Provided are a backup system and a backup method for backing up data written by a host into a logical volume provided by a storage system, wherein an update location in the logical volume updated by the host is managed, and the storage system is controlled to selectively back up the data written into the update location in the logical volume based on the management result of the update location. It is thereby possible to ensure a fast data read speed in the backup of raw volumes and an easy multiplatform backup, whereby a backup system and a backup method capable of performing backup efficiently are realized.

### TECHNICAL FIELD

The present invention can be suitably applied to computer systems of various configurations equipped with a backup function for backing up data written into a logical volume provided by a storage system.

### BACKGROUND ART

Conventionally, with computer systems, so-called backup of copying data stored in a storage system or the like to an external media such as a tape for the protection of data is being widely performed. In addition, dedicated software (this is hereinafter referred to as the “backup software”) for performing this kind of backup is also widely available. Backup based on this kind of backup software is carried out, for instance, by employing a snapshot function and a data replication function provided by the storage system to create a snapshot of a volume that is being used by the application, and copying data from such snapshot to an external media.

There are basically two methods of backup; namely, a file backup method and a raw volume backup method. With the file backup method, data that is stored in the storage system is read in file units through a file system and recorded in an external media. With the raw volume backup method, data that is stored in the storage system is read in volume units and recorded in an external media.

With the file backup method, since data of the storage system is read through the file system as described above, the backup software is able to recognize the data in file units, and there is an advantage in that it is possible to back up only the portions where data is actually written. Further, according to the file backup method, it is also possible to back up only the data that was updated from the previous backup by checking the date and time that the file of the data to be backed up was updated. The process of backing up only the portion that was updated from the previous backup is referred to as an incremental backup. If the entire backup data is acquired initially with the incremental backup, the backup capacity can be considerably reduced since any subsequent backup can be performed with only the incremental backup.

However, with the file backup method, since data is read in file units through the file system, it is possible to back up only the data of the file system that can be recognized by the backup software. Thus, a multiplatform backup is possible only with a file system that corresponds with the backup software. Moreover, the reading of data through a file system generally has a problem in that it takes more time than the reading of raw volume data.

Meanwhile, with the raw volume backup method, the backup software reads the data in the storage system as a raw volume (that is, it reads the entire data in the volume), and records such data in an external media. In other words, the raw volume backup method is characterized in that the data read speed is faster in comparison to the file backup method since the entire data of the raw volume from beginning to end is read. Moreover, the raw volume backup method is advantageous in that a multiplatform backup can be carried out easily since the backup software does not have to recognize the file system.

Nevertheless, since the backup software is unable to recognize files with the raw volume backup method, the data of portions in which valid files are not recorded is also backed up among the volumes to be backed up. In addition, since the backup software is unable to recognize which portions among the data to be backed up have been updated from the previous backup with the raw volume backup method, there is a problem in that the incremental backup cannot be performed, and the entire volume must be backed up at all times.

### DISCLOSURE OF THE INVENTION

With the backup employing the foregoing conventional technology, the data read speed and backup capacity are of a tradeoff relationship, and there is a problem in that it is not possible to perform high-speed backup on the one hand and reduce the backup capacity on the other.

The present invention was devised in view of the foregoing points. Thus, an object of the present invention is to propose a backup system and a backup method capable of performing backup efficiently.

In order to achieve the foregoing object, the present invention provides a backup system for backing up data written by a host into a logical volume provided by a storage system. This backup system comprises an update location management unit for managing an update location in the logical volume updated by the host, and a backup control unit for controlling the storage system to selectively back up the data written into the update location in the logical volume based on the management result of the update location management unit.

The present invention additionally provides a backup method for backing up data written by a host into a logical volume provided by a storage system. This backup method comprises a first step of managing an update location in the logical volume updated by the host, and a second step of controlling the storage system to selectively back up the data written into the update location in the logical volume based on the management result of the update location.

Consequently, according to the present invention, reduction in the backup capacity based on the incremental backup as with the file backup method can be expected while securing a fast data read speed in the backup of raw volumes, whereby a backup system and a backup method capable of performing backup efficiently can be realized.

### BRIEF DESCRIPTION OF THE DRAWINGS

FIG. 1 is a block diagram showing the overall configuration of a computer system according to the first and third embodiments;

FIG. 2 is a block diagram showing the configuration of a storage system according to the first and third embodiments;

FIG. 3 is a block diagram explaining the various control programs and various control data stored in a memory of the storage system;

FIG. 4 is a conceptual diagram showing the configuration of a bitmap management table;

FIG. 5 is a conceptual diagram showing the configuration of a group management table;

FIG. 6A is a flowchart showing the processing routine of a management host for the backup employing the backup method of an embodiment of the present invention;

FIG. 6B is a flowchart showing the processing routine of a management host for the backup employing the backup method of an embodiment of the present invention;

FIG. 7 is a flowchart showing the processing routine of the bitmap recording processing;

FIG. 8 is a flowchart showing the processing routine of the bitmap operation command reception processing;

FIG. 9 is a flowchart showing the processing routine of the logical volume addition processing;

FIG. 10 is a flowchart showing the processing routine of the update bitmap creation processing;

FIG. 11 is a flowchart showing the processing routine of the update bitmap staticization processing;

FIG. 12 is a flowchart showing the processing routine of the update bitmap read processing;

FIG. 13 is a flowchart showing the processing routine of the update bitmap deletion processing;

FIG. 14 is a block diagram showing the overall configuration of a computer system according to the second and third embodiments;

FIG. 15 is a block diagram showing the schematic configuration of a storage system according to the second and third embodiments;

FIG. 16 is a conceptual diagram showing the configuration of a mapping table; and

FIG. 17 is a flowchart showing the processing routine of the allocation bitmap read processing.

### BEST MODE FOR CARRYING OUT THE INVENTION

An embodiment of the present invention is now explained in detail with reference to the attached drawings.

### (1) First Embodiment

(1-1) Overall Configuration of Computer System in this Embodiment

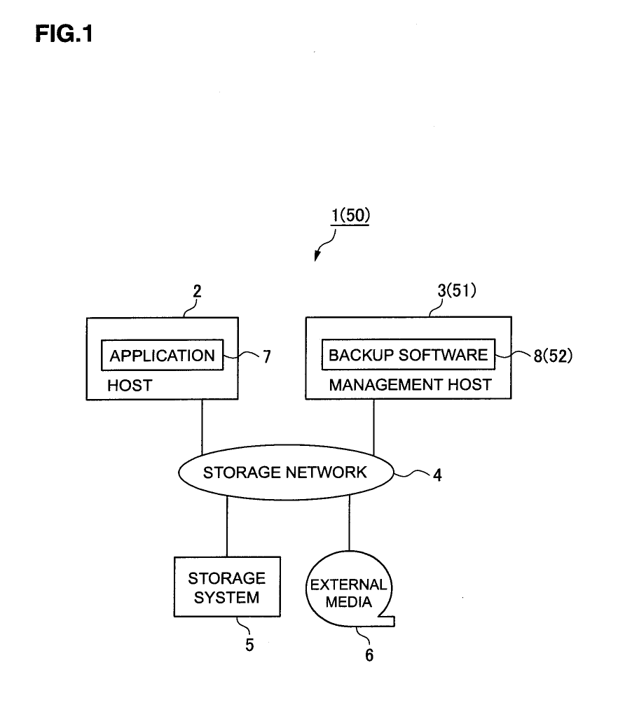

FIG. 1 shows the overall computer system 1 according to the present embodiment. The computer system 1 is configured by a host 2 and a management host 3 being connected to a storage system 5 via a storage network 4, and an external media 6 being connected to the storage system 5 via the storage network 4.

The host 2 is a computer device comprising information processing resources such as a CPU (Central Processing Unit) and a memory, and is configured, for instance, from a personal computer, a workstation or a mainframe. The host 2 is loaded with prescribed application software (this is hereinafter simply referred to as the “application”) 7, and the host 2 executes prescribed data processing based on the application 7, and reads and writes necessary data from and into the storage system 5 via the storage network 4.

The management host 3 is also a computer device comprising information processing resources such as a CPU and a memory, and is configured, for instance, from a personal computer, a workstation or a mainframe.

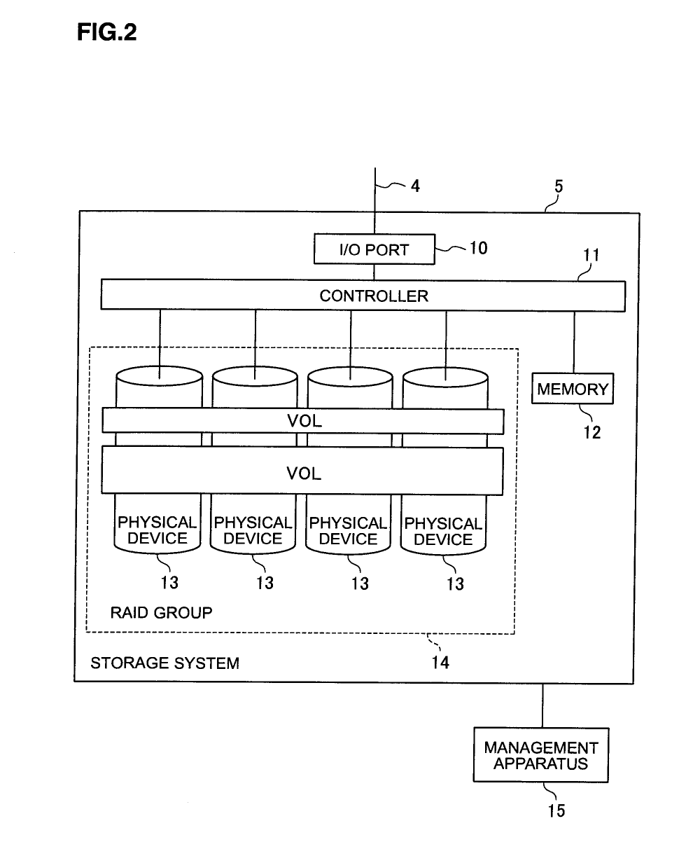

FIG. 2 shows a schematic configuration of the storage system 5. The storage system 5 is configured, as shown in FIG. 2, from an I/O port 10, a controller 11, a memory 12 and a plurality of physical devices 13.

The I/O port 10 is a port for connecting the storage system 5 to the storage network 4. The storage system 5 sends and receives data and commands to and from the host 2 and the management host 3 via the I/O port. Assigned to the I/O port 10 is a network address such as a WWN (World Wide Name) or an IP (Internet Protocol) address for uniquely identifying the I/O port 10 in the storage network 4.

The controller 11 is a processor for governing the operational control of the overall storage system 5. As described later, by the controller 11 executing various control programs stored in the memory 12, the storage system 5 is able to execute various types of control processing as a whole.

The memory 12 is configured, for example, from a nonvolatile semiconductor memory, and stores various control programs and control data. The memory 12 is also used as a cache memory for temporarily storing data to be read from and written into the physical device 13.

The physical devices 13 are configured, for instance, from expensive disks such as SCSI (Small Computer System Interface) disks or inexpensive disks such as SATA (Serial AT Attachment) disks or optical disks. A plurality of physical devices 13 configure one RAID (Redundant Arrays of Inexpensive Disks) group 14, and one or more logical volumes (these are hereinafter referred to as the “logical volumes”) VOL are set in a physical storage area provided by the plurality of physical devices 13 configuring the one RAID group 14. Data from the host 2 is stored in block units based on blocks (there are hereinafter referred to as the “logical blocks”) of a prescribed size in the logical volume VOL.

A unique identifier (this is hereinafter referred to as the “volume ID”) is assigned to each logical volume VOL. In the case of this embodiment, the I/O of data is carried out by combining the volume ID and a unique number (LBA: Logical Block Address) that is assigned to each logical block and using this as an address, and then designating such address.

The management apparatus 15 is configured, for example, from a notebook personal computer, and is used for the maintenance and management of the storage system 5. The management apparatus 15 may also be equipped with a function of giving special instructions to the storage system 5.

(1-2) Backup Method in this Embodiment

The backup method adopted in the computer system 1 is now explained.

The computer system 1 adopts a backup method that applies incremental backup to the raw volume backup method. Specifically, the computer system 1 uses a bitmap (this is hereinafter referred to as the “update bitmap”) to manage the update location of the logical volume VOL to be backed up in the storage system 5, and, during the backup, selectively backs up (incrementally backs up) only the data of portions that were updated between the previous backup and the current backup.

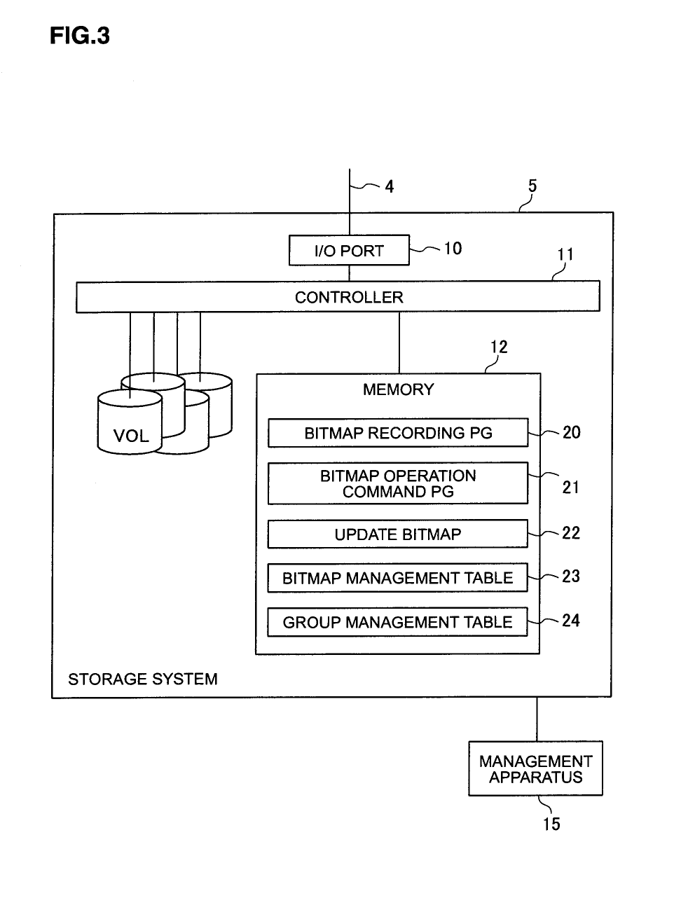

As the means for performing the backup based on the foregoing backup method, the backup software 8 is loaded in the management host 3, and the memory 12 of the storage system 5 stores, as shown in FIG. 3, a bitmap recording program 20, a bitmap operation command program 21, an update bitmap 22, a bitmap management table 23 and a group management table 24.

The backup software 8 is a control program for executing the backup based on the foregoing backup method under the control of the management host 3. The management host 3 controls the storage system 5 and the external media 6 based on the backup software 8 so as to back up the data stored in the logical volume VOL to be backed up existing in the storage system 5, for instance, periodically, in the external media 6.

The bitmap recording program 20 is a control program for managing the update location of the logical volume VOL to be backed up. The bitmap operation command program 21 is a control program for executing the processing of creating, changing and deleting the update bitmap 22 according to instructions from the management host 3.

The update bitmap 22 is a bitmap that is used for managing the update location in the logical volume VOL, and is created for each logical volume VOL to be backed up.

With the update bitmap 22, each bit is associated with different subsections in each of the corresponding logical volumes VOL. For instance, if 1 bit of the update bitmap 22 is associated with one logical block (512 Bytes) of the logical volume VOL, and that logical volume VOL has a capacity of 1 TB, and the capacity of the corresponding update bitmap 22 will be 2 Gbit (=256 MB).

Incidentally, by enlarging the size of the subsections (for instance to 4 KB), it will be possible to manage the update location of a logical volume VOL with a larger capacity using an update bitmap 22 with a smaller capacity. The update bitmap 22 is created by the controller 11 securing an unused area of the required capacity in the memory 12.

The bitmap management table 23 is a table for managing the update bitmap 22 associated with the logical volume VOL, and is created for each logical volume VOL to be backed up. In this embodiment, since the update bitmap 22 is switched each time backup is performed as described later, a plurality of update bitmaps 22 are associated with a single logical volume VOL. Thus, the controller 11 uses the bitmap management table 23 to manage the update bitmap 22 that is associated with the respective logical volumes VOL.

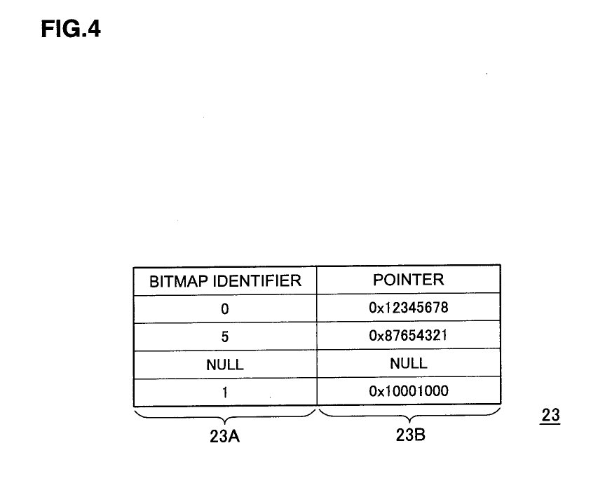

As shown in FIG. 4, the bitmap management table 23 has a plurality of entries, and these entries correspond to their respective update bitmaps 22 associated with the logical volume VOL corresponding to the bitmap management table 23. Accordingly, in the example shown in FIG. 4, up to four update bitmaps 22 can be associated with the logical volume VOL.

With the bitmap management table 23, one entry is configured from a bitmap identifier column 23A and a pointer column 23B. The bitmap identifier column 23A stores an identifier that is assigned to the update bitmap 22 corresponding to that entry, and the pointer column 23B stores a start address of that update bitmap 22 created in the memory 12. Incidentally, in FIG. 4, entries in which “NULL” is stored in the bitmap identifier column 23A and the pointer column 23B are not associated with the update bitmap 22.

Accordingly, in the case of the example shown in FIG. 4, three update bitmaps 22 respectively assigned with the identifiers of “0,” “5” and “1” are associated with the logical volume VOL corresponding to the bitmap management table 23, and it can be seen that the start addresses in the memory 12 of these update bitmaps 22 are respectively “0x12345678,” “0x87654321” and “0x10001000.” Here, “0x” is a prefix representing a hexadecimal number.

Since the update bitmap 22 is switched each time backup is performed in this embodiment as described above, when data is written into the corresponding logical volume VOL, there will be an update bitmap 22 that is updated pursuant to such writing and an update bitmap 22 that will not be updated. In the following explanation, an update bitmap 22 that is updated according to the update in the contents of the corresponding logical volume VOL is referred to as an “active update bitmap 22,” and an update bitmap 22 that is not updated even when the contents of the corresponding logical volume VOL are updated is referred to as a “staticized update bitmap 22.” Zero or one active update bitmap 22 and zero or more staticized update bitmaps 22 are associated with a single logical volume VOL.

Further, in the following explanation, “0” will be assigned as the identifier to the active update bitmap 22, and a number other than “0” will be assigned as the identifier to the staticized update bitmap 22. Accordingly, if an entry in which the identifier of “0” is stored in the bitmap identifier column 23A does not exist in the bitmap management table 23 corresponding to a certain logical volume VOL, it means that an active update bitmap 22 does not exist in that logical volume VOL (i.e., even if that logical volume VOL is updated, there is no update bitmap 22 to be updated). However, the differentiation of the active update bitmap 22 and the staticized update bitmap 22 is not limited to the foregoing method.

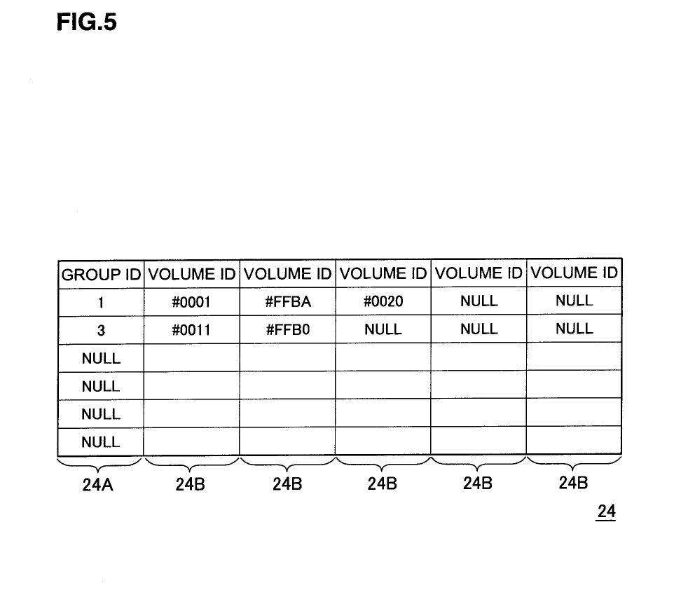

Meanwhile, the group management table 24 is a table for managing a group (this is hereinafter simply referred to as the “group”) configured from one or more logical volumes VOL provided in the storage system 5. The group management table 24 includes a plurality of entries as shown in FIG. 5, and these entries are respectively associated with a single group.

Each entry is configured from a group ID column 24A and a plurality of volume ID columns 24B, and the ID assigned to the group corresponding to that entry is stored in the group ID column 24A, and the volume ID of the respective logical volumes VOL configuring that group is stored in each volume ID column 24B. Moreover, “NULL” in FIG. 5 shows that nothing is applicable.

Accordingly, in the case of the example shown in FIG. 5, it is understood that the group management table 24 can be used to manage up to six groups, and each group can be configured from a maximum of five logical volumes VOL. In addition, currently two groups exist in FIG. 5, and, for instance, the group assigned with the group ID of “1” is configured from three logical volumes VOL respectively assigned with the volume IDs of “#0001,” “#FFBA” and “#0020,” and the group assigned with the group ID of “3” is configured from two logical volumes VOL respectively assigned with the volume IDs of “#0011” and “#FFB0.”

Although the group management table 24 is illustrated as being configured in a simple two-dimensional table format in order to simplify the explanation, the group management table 24 may be configured in any way so as long as it is possible to identify the logical volumes VOL configuring that group from the group ID. In addition, the number of groups that can be managed and the maximum number of logical volumes VOL configuring a group are not limited to this exemplification.

As described above, in this embodiment, as a result of managing the logical volumes VOL in groups, the operation of the update bitmaps 22 corresponding to the respective logical volumes VOL; for instance, the staticization of the update bitmap 22, can be collectively commanded in group units. Generally speaking, the application 7 loaded in the host 2 often executes processing using a plurality of logical volumes VOL, and the backup is also often executed targeting a group of logical volumes VOL used by the application 7. Accordingly, the group management function of grouping and managing the logical volumes VOL as described above is able to increase the convenience in the backup processing.

### (1-3) Processing of Management Host for Backup

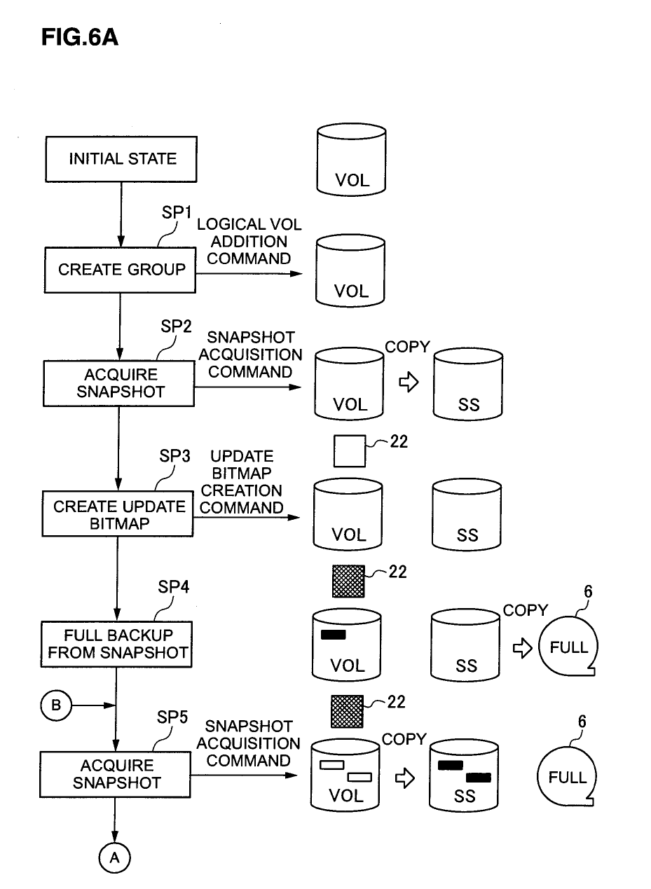

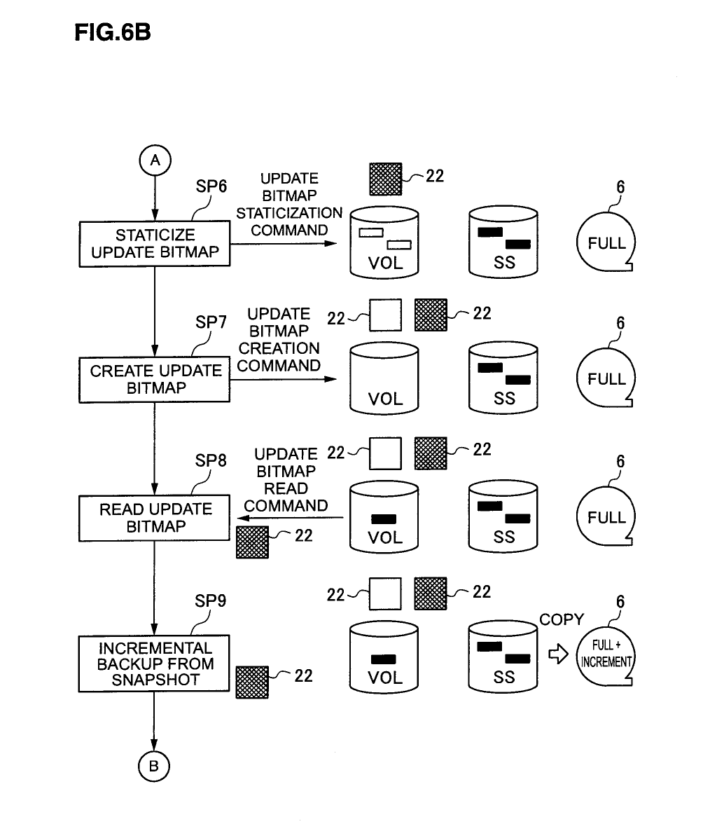

FIG. 6A and FIG. 6B show the specific processing contents of the management host 3 for performing the backup based on the backup method according to the present embodiment as described above. The management host 3 executes the backup processing shown in FIG. 6A and FIG. 6B based on the backup software 8 (FIG. 1).

Specifically, as the initialization of backup processing, the management host 3 foremost issues a logical volume addition command to the storage system 5 so as to add the logical volume VOL to be backed up in the storage system 5 to an appropriate group (SP1).

Subsequently, the management host 3 controls the application 7 that is running on the host 2 via a communication channel or the like between hosts, or controls the storage system 5 so as to suspend the update of that logical volume VOL according to the request from the host 2, and thereafter issues a snapshot acquisition command to the storage system 5 so as to cause the storage system 5 to create a snapshot SS of that logical volume VOL (SP2).

Subsequently, the management host 3 sends an update bitmap creation command to the storage system 5 so as to cause the storage system 5 to create an active update bitmap 22 corresponding to that logical volume VOL. The management host 3 controls the application 7 running on the host 2 or controls the storage system 5 so as to resume the updating of the logical volume VOL according to the write request from the host 2 (SP3). Consequently, the storage system 5 will subsequently record the update location of that logical volume VOL in the active update bitmap 22 according to the update of such logical volume VOL.

Subsequently, the management host 3 controls the storage system 5 so as to fully back up the snapshot SS acquired at step SP3 to the external media 6 (SP4). Data of the snapshot SS created at step SP2 is thereby transferred between the storage system 5 and the external media 6, and the full backup of the snapshot SS is stored in the external media 6.

Subsequently, when it becomes the timing for the next backup, the management host 3 controls the application 7 running on the host 2 or controls the storage system 5 so as to suspend the updating of the logical volume VOL according to the write request from the host 2, and then issues a snapshot acquisition command to the storage system 5 so as to cause the storage system 5 to create a snapshot SS of that logical volume VOL once again (SP5).

Subsequently, the management host 3 issues an update bitmap staticization command to the storage system 5 so as to staticize the active update bitmap 22 associated with that logical volume VOL at such time (SP6). When the active update bitmap 22 is staticized as described above, this means that the update bitmap 22 has recorded the update location of the logical volume VOL during the period between the previous backup and the current backup.

Subsequently, the management host 3 issues an update bitmap creation command to the storage system 5 so as to cause the storage system 5 to create the subsequent active update bitmap 22 corresponding to that logical volume VOL. The management host 3 additionally controls the application 7 running on the host 2 or controls the storage system 5 so as to resume the writing of data into that logical volume VOL according to the write request from the host 2 (SP7). Consequently, the storage system 5 will subsequently record the update location of that logical volume according to the update of such logical volume in the newly prepared active update bitmap 22.

Subsequently, the management host 3 issues an update bitmap read command to the storage system 5 so as to transfer the update bitmap 22 that was staticized at step SP6 to the management host 3 (SP8).

Moreover, while referring to the update bitmap 22 acquired as described above, the management host 3 thereafter controls the storage system 5 so as to read only the data (this is hereinafter referred to as the “incremental data”) of the portions updated in the logical volume VOL to be backed up during the period between the previous backup and the current backup from the snapshot SS and transfer such incremental data to the external media 6 (SP9). Incidentally, since the backup processing performed here only backs up the incremental data from the previous backup unlike a full backup, it is necessary to simultaneously record the location information of the updated portions in the external media 6. This can be realized, for example, by the storage system 5 recording the staticized update bitmap 22 together with the storage system 5 in the external media 6 at step SP6.

Subsequently, the management host 3 repeats the processing at step SP5 to step SP9. It is thereby possible to sequentially back up (incrementally back up) only the updated portions in that logical volume VOL.

Needless to say, by merging the incremental data acquired as described above and the full backup data, it is possible to reproduce the full backup image at the time the incremental backup was executed. Accordingly, it is also possible to read only the incremental data from the logical volume VOL, reproduce a new full backup image by merging the read incremental data and the full backup that was acquired before then, and store this in the external media 6.

Moreover, with the backup method of this embodiment described above, the oldest full backup and the incremental backup of the portions that were updated during the respective backup acquisitions will be accumulated. Here, the processing upon restoring the backup after acquiring several incremental backups will be considered.

In the foregoing case, in order to reproduce the newest backup image, it is necessary to once restore the full backup to an appropriate logical volume VOL (to be generally selected by the backup software 8 according to the unused logical volume and the like), and then sequentially restore the entire incremental backup data. Thus, there is a problem in that the restoration time will become long.

Thus, there is a method of initially acquiring the full backup of the snapshot SS at step SP4 of FIG. 6A, and subsequently acquiring the backup of only the portions that were updated from the full backup at the time of each backup acquisition. This is generally referred to as a differential backup. As a result of employing this kind of differential backup, although the backup capacity will increase in comparison to the incremental backup, the restoration time can be shortened since the restoration will be complete merely by restoring the full backup and one differential backup during the restoration process.

In order to realize the differential backup by employing the present invention, for instance, there is a method where the backup software 8 merges the update bitmaps 22. The backup software 8 previously stores the update bitmaps 22, and, upon newly acquiring a backup, acquires such backup with the result of the logical sum of the update bitmap 22 that was read as a result of issuing an update bitmap read command to the storage system 5, and the update bitmap 22 stored in the backup software 8 as the update location information. In addition, the stored update bitmaps 22 are replaced based on the result of the logical sum. By repeating this process, all update locations that were updated after the full backup will be recorded in the update bitmaps 22 retained by the backup software 8, and the differential backup can be achieved thereby.

Moreover, for instance, an update bitmap read command may be expanded so that it can designate a plurality of update bitmaps 22 (for example, so it can designate a plurality of identifiers of the update bitmaps 22 to be read), and the storage system 5 that received such update bitmap read command may send the logical sum of all designated update bitmaps 22 to the backup software 8, and the backup software 8 may perform the differential backup according to that update bitmap 22. Based on this method, the backup software 8 will no longer have to store the update bitmap 22.

### (1-4) Processing of Controller of Storage System for Backup

### (1-4-1) Bitmap Recording Processing

The specific processing contents of the controller 11 of the storage system 5 for the backup based on the backup method of the present embodiment are now explained.

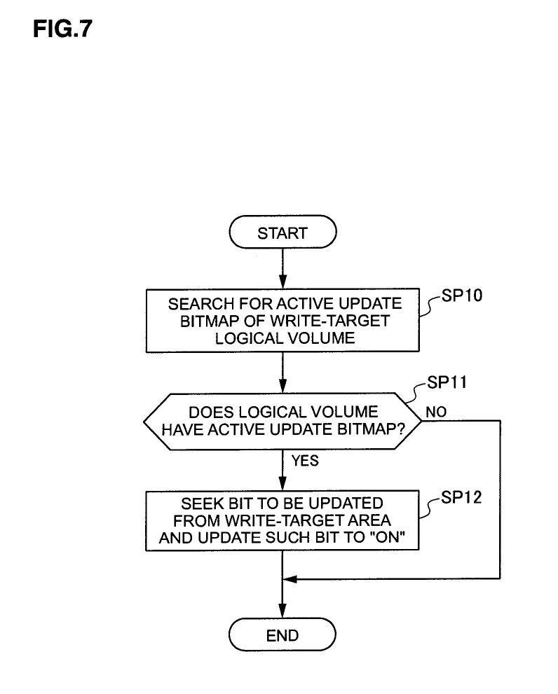

To begin with, how the controller 11 manages the update location of the logical volume VOL updated according to the write request from the host 2 is explained with reference to FIG. 7.

FIG. 7 shows the processing routine of the controller 11 in a case where a write request is issued from the host 2. The controller 11 executes the bitmap recording processing shown in FIG. 7 according to the bitmap recording program 20 (FIG. 3).

Specifically, when the controller 11 receives the write request from the host 2, it starts this bitmap recording processing, and, among the update bitmaps 22 associated with the logical volume VOL into which data is to be written, foremost searches for an active update bitmap 22 (that is, the update bitmap 22 in which the identifier is “0”) in the bitmap management table 23 of that logical volume VOL (SP10).

Subsequently, the controller 11 determines whether the logical volume VOL into which data is to be written has an active update bitmap 22 based on the search result at step SP10 (SP11), and, upon obtaining a negative result, ends this bitmap recording processing.

Meanwhile, if the controller 11 obtains a positive result in the determination at step SP11, it calculates the update location in the active update bitmap 22 based on the write start location and write size contained in the write request, and sets the bit of the target area in that update bitmap 22 to ON (“ON”) (SP12). The controller 11 thereafter ends this bitmap recording processing.

### (1-4-2) Bitmap Operation Command Reception Processing

The flow of various types of processing to be executed by the controller 11 when the controller 11 receives a command (this is hereinafter referred to as the “bitmap operation command”) for backup from the management host 3 is now explained.

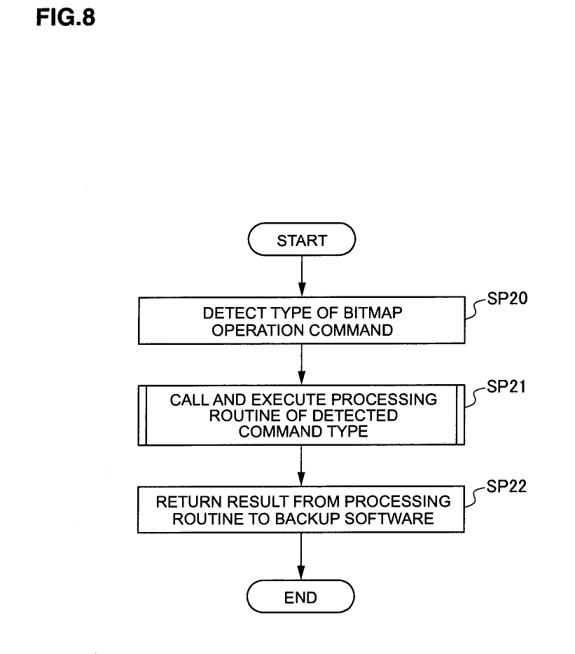

FIG. 8 shows the processing contents of the bitmap operation command reception processing to be executed by the controller 11 upon receiving a bitmap operation command from the management host 3. The controller 11 executes this bitmap operation command reception processing based on the bitmap operation command program 21.

Specifically, the controller 11 starts the bitmap operation command reception processing upon receiving a bitmap operation command from the management host 3, and foremost seeks the type of bitmap operation command based on the type parameter contained in that bitmap operation command (SP20). Incidentally, as the command type of the bitmap operation command, there are an update bitmap creation command, an update bitmap staticization command, an update bitmap read command, an update bitmap deletion command, and a logical volume addition command.

Subsequently, the controller 11 calls the processing routine corresponding to the command type sought at step SP20 and executes that processing routine (SP21), and thereafter notifies the processing result of the processing based on that processing routine to the management host 3 (SP22). The controller 11 thereafter ends this bitmap operation command reception processing.

### (1-4-3) Logical Volume Addition Processing

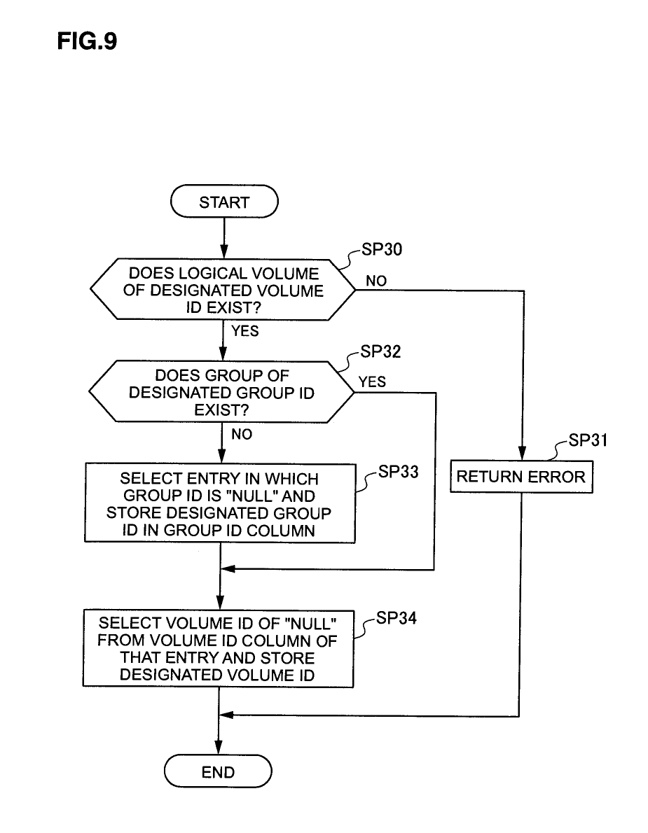

FIG. 9 shows the processing routine of the logical volume addition processing to be executed by the controller 11 at step SP21 of FIG. 8 if it is determined that the bitmap operation command from the management host 3 is a logical volume addition command at step SP20 of FIG. 8 (for instance, upon receiving the logical volume addition command issued by the management host 3 at step SP1 of FIG. 6A).

When the controller 11 receives the logical volume addition command and proceeds to step SP21 of FIG. 8, it starts this logical volume addition processing, and foremost determines whether a logical volume VOL of the volume ID designated as the volume ID of the logical volume VOL to be added exists (SP30). This determination is made by referring to the logical volume management table (not shown) retained in the memory 12 and which registers the volume ID of the respective logical volumes VOL existing in the storage system 5.

If the controller 11 obtains a negative result in this determination, it returns an error to the bitmap operation command program 21 (SP31), and thereafter ends this logical volume addition processing.

Meanwhile, if the controller 11 obtains a positive result in the determination at step SP30, it refers to the group management table 24 (FIG. 5) and determines whether a group assigned with the group ID designated in the logical volume addition command as the group ID of the group to which the logical volume VOL is to be added exists (SP32).

If the controller 11 obtains a positive result in this determination it proceeds to step SP34. Meanwhile, if the controller 11 obtains a negative result in this determination, it selects an entry in which “NULL” is stored in the group ID column 24A of the group management table 24, and stores the group ID designated in the logical volume addition command as the group ID of the group to which the logical volume VOL is to be added in the group ID column 24A of that entry (SP33).

The controller 11 thereafter selects the volume ID column 24B storing “NULL” in the volume ID column 24B of that entry, and stores in that volume ID column 24B the volume ID designated as the volume ID of the logical volume VOL to be added in the logical volume addition command (SP34). The controller 11 thereafter ends this logical volume addition processing.

### (1-4-4) Update Bitmap Creation Processing

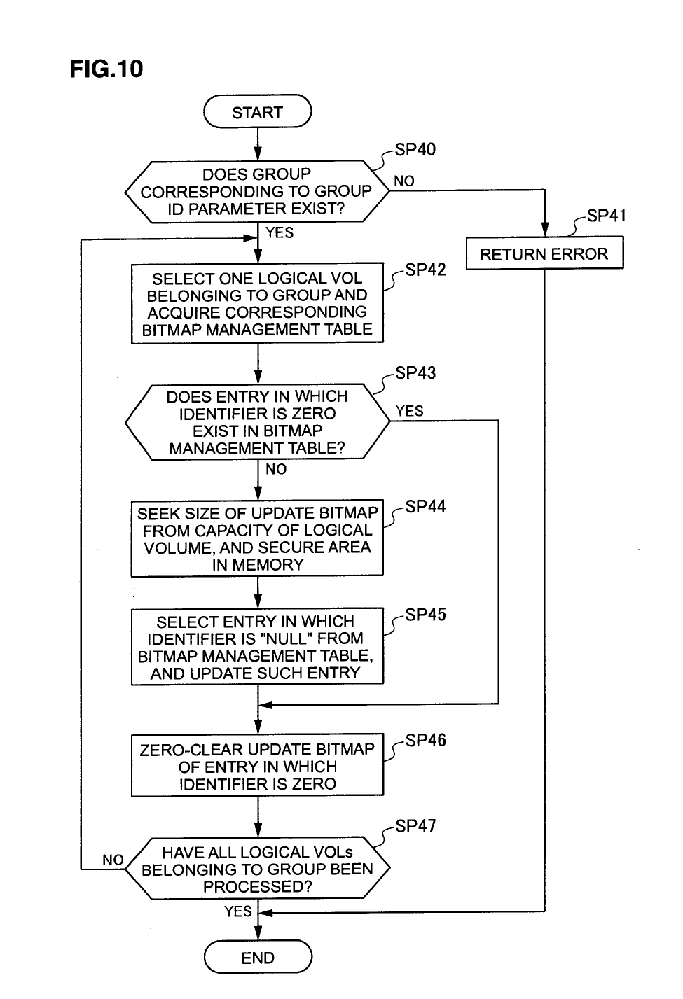

Meanwhile, FIG. 10 shows the processing routine of the update bitmap creation processing to be executed by the controller 11 at step SP21 of FIG. 8 if it is determined that the bitmap operation command from the management host 3 is an update bitmap creation command at step SP20 of FIG. 8 (upon receiving the update bitmap creation command issued by the management host 3 at step SP3 or the like of FIG. 6A).

When the controller 11 receives the update bitmap creation command and proceeds to step SP21 of FIG. 8, it starts the update bitmap creation processing, and foremost refers to the group management table 24 (FIG. 5) and determines whether the group of the group ID designated in the update bitmap creation command as the group ID of the group configured from the logical volumes VOL to which the update bitmap 22 is to be created exists (SP40).

If the controller 11 obtains a negative result in this determination, it returns an error to the bitmap operation command program 21 (FIG. 3) (SP41), and thereafter ends this update bitmap creation processing.

Meanwhile, if the controller 11 obtains a positive result in the determination at step SP40, it refers to the group management table 24 and selects one logical volume VOL configuring the group of the group ID designated in the update bitmap creation command, and reads the bitmap management table 23 (FIG. 4) corresponding to the selected logical volume VOL from the memory 12 (FIG. 2) (SP42).

Subsequently, the controller 11 refers to the read bitmap management table 23 and determines whether an entry in which “0” is stored in the bitmap identifier column 23A exists (SP43).

To obtain a positive result in this determination means that the logical volume VOL selected at step SP42 is related to an active update bitmap 22. Consequently, the controller 11 proceeds to step SP46.

Meanwhile, to obtain a negative result in the determination at step SP43 means that the logical volume VOL selected at step SP42 is not related to an active update bitmap 22. Consequently, the controller 11 calculates the necessary size as the update bitmap 22 for that logical volume VOL based on the capacity of that logical volume VOL, and allocates the unused area for that size in the memory 12 (SP44).

Subsequently, the controller 11 selects an entry in which “NULL” is stored in the bitmap identifier column 23A among the entries of the bitmap management table 23, and stores “0” in the bitmap identifier column 23A and the top address of the unused area allocated at step SP44 in the pointer column 23B, respectively (SP45).

The controller 11 thereafter zero-clears update bitmap 22 in the memory 12 based on the address stored in the pointer column 23B of that entry (SP46).

The controller 11 additionally determines whether similar processing has been executed regarding all logical volumes VOL belonging to the group of the group ID designated in the update bitmap creation command (SP47). If the controller 11 obtains a negative result in this determination, it returns to step SP42 and thereafter repeats similar processing until a positive result is obtained at step SP47 (SP42 to SP47-SP42).

When the controller 11 eventually obtains a positive result at step SP47 upon completing the similar processing regarding all logical volumes VOL belonging to the group of the group ID designated in the update bitmap creation command, it ends this update bitmap creation processing.

### (1-4-5) Update Bitmap Staticization Processing

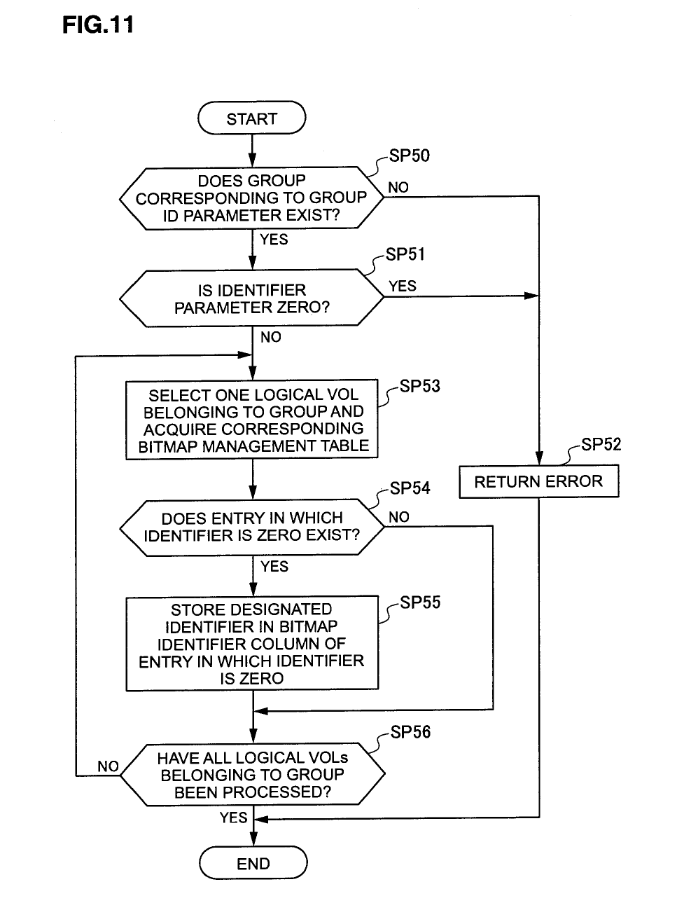

Meanwhile, FIG. 11 shows the processing routine of the update bitmap staticization processing to be executed by the controller 11 at step SP21 of FIG. 8 if it is determined that the bitmap operation command from the management host 3 is an update bitmap staticization command at step SP20 of FIG. 8 (upon receiving the update bitmap staticization command issued by the management host 3 at step SP6 of FIG. 6B).

When the controller 11 receives the update bitmap staticization command it proceeds to step SP21 of FIG. 8 and starts this update bitmap staticization processing, and foremost refers to the group management table 24 (FIG. 5) and determines whether a group of the group ID designated in the update bitmap staticization command as the group ID of the group configured from the logical volumes VOL to which the corresponding update bitmap 22 is to be staticized exists (SP50).

If the controller 11 obtains a negative result in this determination, it returns an error to the bitmap operation command program 21 (FIG. 3) (SP52), and thereafter ends this update bitmap staticization processing.

Meanwhile, if the controller 11 obtains a positive result in the determination at step SP50, it determines whether the identifier of the update bitmap 22 to be staticized designated in the update bitmap staticization command is “0” (SP51).

If the controller 11 obtains a positive result in this determination, it proceeds to step SP52. Meanwhile, if the controller 11 obtains a negative result in this determination, it refers to the group management table 24 (FIG. 5) and selects one logical volume VOL configuring the group of the group ID designated in the update bitmap staticization command, and reads the bitmap management table 23 (FIG. 4) corresponding to the selected logical volume VOL from the memory 12 (SP53).

Subsequently, the controller 11 refers to the read bitmap management table 23, and determines whether an entry in which “0” is stored in the bitmap identifier column 23A exists (SP54).

To obtain a negative result in this determination means that the logical volume VOL selected at step SP53 is not related to an active update bitmap 22. Consequently, the controller 11 proceeds to step SP56.

Meanwhile, to obtain a positive result in this determination at step SP54 means that the logical volume VOL selected at step SP53 is related to an active update bitmap 22. Consequently, the controller 11 changes the identifier of the active update bitmap 22 to the identifier designated in the update bitmap staticization command. Specifically, the controller 11 changes the identifier stored in the bitmap identifier column 23A of the entry corresponding to the active update bitmap 22 in the bitmap management table 23 to the identifier designated in the update bitmap staticization command (SP55).

The controller 11 additionally determines whether similar processing has been executed regarding all logical volumes VOL belonging to the group of the group ID designated in the update bitmap staticization command (SP56). If the controller 11 obtains a negative result in this determination, it returns to step SP53 and thereafter repeats similar processing until a positive result is obtained at step SP56 (SP53 to SP56-SP53).

When the controller 11 eventually obtains a positive result at step SP56 upon completing the similar processing regarding all logical volumes VOL belonging to the group of the group ID designated in the update bitmap staticization command, it ends this update bitmap staticization processing.

### (1-4-6) Update Bitmap Read Processing

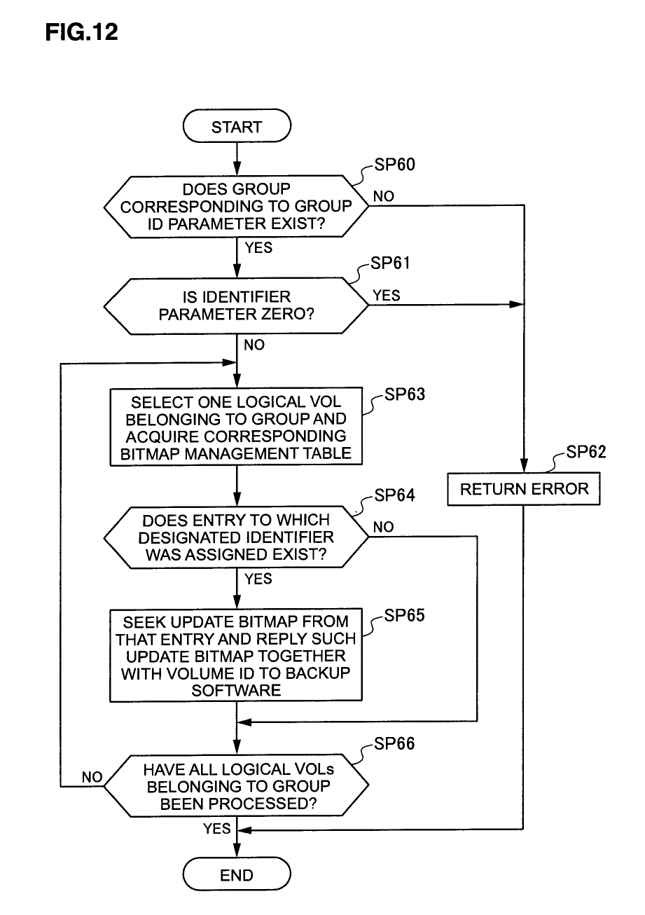

Meanwhile, FIG. 12 shows the processing routine of the update bitmap read processing to be executed by the controller 11 at step SP21 of FIG. 8 if it is determined that the bitmap operation command from the management host 3 is an update bitmap read command at step SP20 of FIG. 8 (upon receiving the update bitmap read command issued by the management host 3 at step SP6 of FIG. 6B).

When the controller 11 receives the update bitmap read command it proceeds to step SP21 of FIG. 8 and starts this update bitmap read processing, and foremost refers to the group management table 24 (FIG. 5) and determines whether a group of the group ID designated in the update bitmap read command as the group ID of the group configured from the logical volumes VOL from which the corresponding update bitmap 22 is to be read exists (SP60).

If the controller 11 obtains a negative result in this determination, it returns an error to the bitmap operation command program 21 (FIG. 3) (SP62), and thereafter ends this update bitmap read processing.

Meanwhile, if the controller 11 obtains a positive result in the determination at step SP60, it determines whether the identifier of the update bitmap 22 to be read designated in the update bitmap read command is “0” (SP61).

If the controller 11 obtains a negative result in this determination, it proceeds to step SP62. Meanwhile, if the controller 11 obtains a positive result in this determination, it refers to the group management table 24 and selects one logical volume VOL configuring the group of the group ID designated in the update bitmap read command, and reads the bitmap management table 23 (FIG. 4) corresponding to the selected logical volume VOL from the memory 12 (SP63).

Subsequently, the controller 11 refers to the read bitmap management table 23 and determines whether an entry corresponding to the update bitmap 22 assigned with the identifier designated in the update bitmap read command exists (SP64).

If the controller 11 obtains a negative result in this determination, it proceeds to step SP66. Meanwhile, if the controller 11 obtains a positive result in this determination, it reads the update bitmap 22 assigned with the identifier designated as the write target in the update bitmap read command from the memory 12, and notifies that data together with the volume ID of the corresponding logical volume VOL selected at step SP63 to the management host 3 (SP65).

The controller 11 additionally determines whether similar processing has been executed regarding all logical volumes VOL belonging to the group of the group ID designated in the update bitmap read command (SP66). If the controller 11 obtains a negative result in this determination, it returns to step SP63 and thereafter repeats similar processing until a positive result is obtained at step SP66.

When the controller 11 eventually obtains a positive result at step SP66 upon completing the similar processing regarding all logical volumes VOL belonging to the group of the group ID designated in the update bitmap read command, it ends this update bitmap read processing.

### (1-4-7) Update Bitmap Deletion Processing

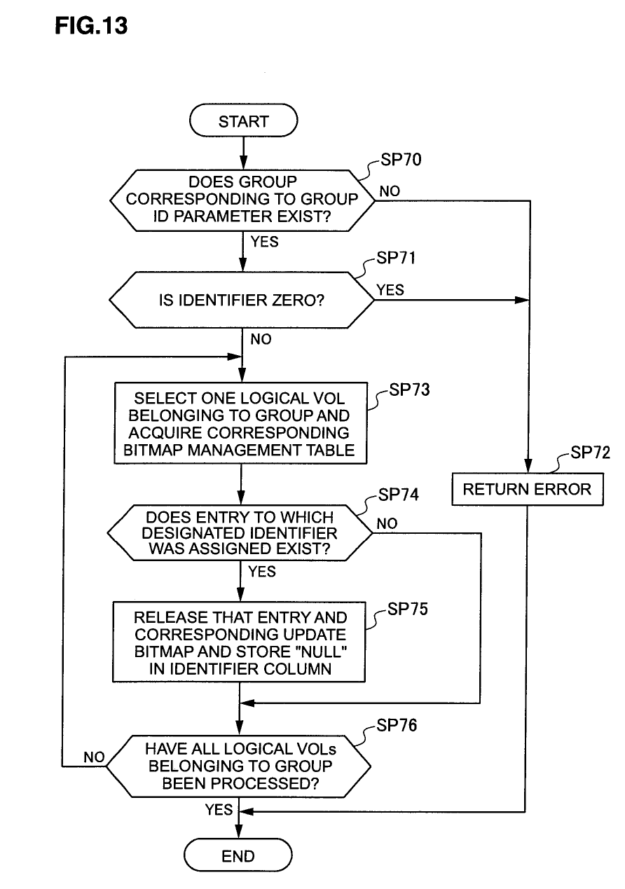

FIG. 13 shows the processing routine of the update bitmap deletion processing to be executed by the controller 11 at step SP21 of FIG. 8 if it is determined that the bitmap operation command from the management host 3 is an update bitmap deletion command at step SP20 of FIG. 8.

When the controller 11 receives the update bitmap deletion command it proceeds to step SP21 of FIG. 8 and starts this update bitmap deletion processing, and foremost refers to the group management table 24 (FIG. 5) and determines whether a group of the group ID designated in the update bitmap deletion command as the group ID of the group configured from the logical volumes VOL from which the corresponding update bitmap 22 is to be deleted (SP70).

If the controller 11 obtains a negative result in this determination, it returns an error to the bitmap operation command program 21 (FIG. 3) (SP72), and thereafter ends this update bitmap deletion processing.

Meanwhile, if the controller 11 obtains a positive result in the determination at step SP70, it determines whether the identifier of the update bitmap 22 to be deleted designated in the update bitmap deletion command is “0” (SP71).

If the controller 11 obtains a negative result in this determination, it proceeds to step SP72. Meanwhile, if the controller 11 obtains a positive result in this determination, it refers to the group management table 24 and selects one logical volume VOL configuring the group of the group ID designated in the update bitmap deletion command, and read the bitmap management table 23 (FIG. 4) corresponding to the selected logical volume VOL from the memory 12 (FIG. 2) (SP73).

Subsequently, the controller 11 refers to the read bitmap management table 23 and determines whether an entry corresponding to the update bitmap 22 assigned with the identifier designated in the update bitmap deletion command exists in the bitmap management table 23 (SP74).

If the controller 11 obtains a negative result in this determination, it proceeds to step SP76. Meanwhile, if the controller 11 obtains a positive result in this determination, it releases the storage area in the memory 12 in which the update bitmap 22 corresponding to the entry is formed based on the address stored in the pointer column 23B of that entry, and changes the identifier stored in the bitmap identifier column 23A of that entry to “NULL” (SP75).

The controller 11 additionally determines whether similar processing has been executed regarding all logical volumes VOL belonging to the group of the group ID designated in the update bitmap deletion command (SP76). If the controller 11 obtains a negative result in this determination, it returns to step SP73 and thereafter repeats similar processing until a positive result is obtained at step SP76.

When the controller 11 eventually obtains a positive result at step SP76 upon completing the similar processing regarding all logical volumes VOL belonging to the group of the group ID designated in the update bitmap deletion command, it ends this update bitmap deletion processing.

(1-5) Effect of this Embodiment

With the computer system 1 according to the present embodiment described above, the update location of the logical volume VOL to be backed up in the storage system 5 is managed using the update bitmap 22, and only the data of portions that were updated during the period between the previous backup and the current backup is selectively backed up during the backup.

Consequently, according to the backup method of the present embodiment, reduction in the backup capacity based on the incremental backup as with the file backup method can be expected while securing a fast data read speed in the backup of raw volumes, whereby a computer system capable of performing backup efficiently can be realized.

### (1-6) Other Embodiments

In the first embodiment described above, although a case was explained where the backup software 8 is executed with the management host 3 provided separately from the host 2, the present invention is not limited thereto, and the host 2 may execute both the application software 7 and the backup software 8.

Moreover, in the first embodiment described above, although a case was explained where the external media 6 is connected to the same storage network 4 as the storage system 5, the present invention is not limited thereto, and the external media 6 may be connected, for instance, directly to the management host 3.

Further, in the first embodiment described above, although a case was explained where the backup software 8 uses the data replication function of the storage system 5 to read data of the application 7 from the snapshot, the present invention is not limited thereto, and, for instance, the execution of the application 7 of the host 2 may be suspended during the backup. According to the foregoing method, since it will be possible to read data of the application 7 directly from the logical volume VOL to be backed up, the processing for creating the replication of data can be omitted.

In addition, in the first embodiment described above, although a case was explained where the update bitmap 22 is provided to the storage system 5 and a function (update location management unit) for recording the update location of the logical volume VOL is loaded in the storage system 5, the present invention is not limited thereto, and the same effects as the present invention can also be obtained by loading software having the function of recording the update location in the host 2.

For example, the foregoing function may be loaded in a device driver (not shown) of an OS (Operating System) to be executed in the host 2. In the foregoing case, it will be possible to realize the incremental/differential backup in the raw volume backup even with standard storage systems that are not equipped with the function explained in the first embodiment. However, in this case, special software like the device driver described above will be necessary. In addition, with the logical volumes VOL that are updated from a plurality of hosts 2, processing for acquiring the update bitmaps 22 from the respective hosts 2 and merging such update bitmaps 22 will be required.

Moreover, in the first embodiment described above, although a case was explained where the management host 3 is equipped with a function (backup control unit) for reading the update bitmap 22 from the storage system 5 and controlling the storage system 5 so as to read only the data of updated portions from the logical volume VOL to be backed up based on that update bitmap 22, the present invention is not limited thereto, and, for instance, a backup dedicated read command (this is hereinafter referred to as the “backup data read command”) may be defined for use at the time that the backup software 8 is to read the backup data.

In the foregoing case, the storage system 5 that received the backup data read command should reply only the data of portions in which the update is recorded in the update bitmap 22 to the management host 3, and reply to the effect that the non-recorded portions are not updated. According to this method, the processing of the management host 3 reading the update bitmap 22 can be omitted.

Further, in the first embodiment described above, although a case was explained where backup is performed only with the backup method according to the present embodiment, the present invention is not limited thereto, and the computer system 1 may be configured so that it is able to perform the backup based on the file backup method.

Incidentally, as described above, with the backup based on the file backup method, it is possible to perform the incremental/differential backup by checking the date and time that the file was updated. The difference between the incremental/differential backup based on the file backup and the incremental/differential backup based on the backup method according to the present embodiment is in the effect of reducing the backup capacity due to the characteristics of the update of data by the application. Specifically, if the application 7 of the host 2 is an application that rewrites a part of a large capacity file, whereas the entire data of the target file will be backed up with the file backup method, only the updated data will be backed up in the backup performed with the backup method of this embodiment. Thus, the effect of reducing the backup capacity is considered to be higher with the backup method of the present embodiment.

Meanwhile, if the application 7 of the host 2 is an application that often executes the deletion of files, whereas the backup of the deleted files will not be required with the backup based on the file backup method, it will be necessary to back up the portions that were updated (primarily the metadata and directory information of the file system) with the backup based on the backup method according to the present embodiment. Thus, the effect of reducing the backup capacity is considered to be higher with the file backup method.

Consequently, it is possible to equip the management host 3 (backup software 8) with a function of pre-setting whether to use the file backup method or the backup method of the present embodiment as the backup method for each logical volume VOL to be backed up. It is thereby possible to select the optimal backup method according to the characteristics of the application 7 loaded in the host 2.

### (2) Second Embodiment

(2-1) Configuration of Storage System in this Embodiment

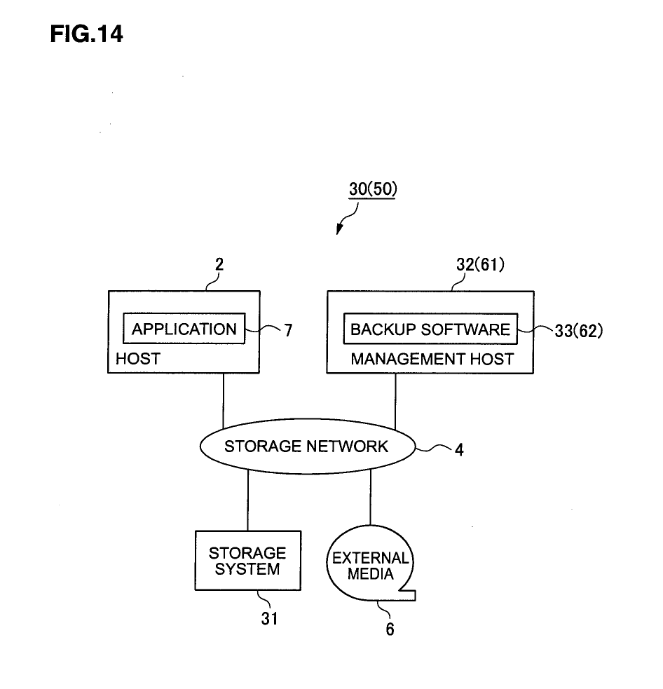

FIG. 14, in which the same reference numerals are shown for the components corresponding to those of FIG. 1, shows a computer system 30 according to the second embodiment. With the computer system 30, the storage system 31 is equipped with a dynamic capacity allocation function, and differs from the storage system 1 according to the first embodiment in that the storage system 31 is able to efficiently back up a virtual logical volume VOL (this is hereinafter referred to as the “virtual volume VOL”) presented by the host 2 in addition to the tangible logical volume VOL (hereinafter referred to as the “real volume VOL” as appropriate) in the dynamic capacity allocation function.

Incidentally, in the following explanation, let it be assumed that the management host 32 and the storage system 31 respectively possess all functions equipped in the management host 3 and the storage system 5 of the first embodiment. Accordingly, with the computer system 30 according to the present embodiment, the explanation will be provided on the assumption that the computer system 30 is able to perform the backup based on the backup method that applies the incremental backup to the raw volume backup method described above in the first embodiment.

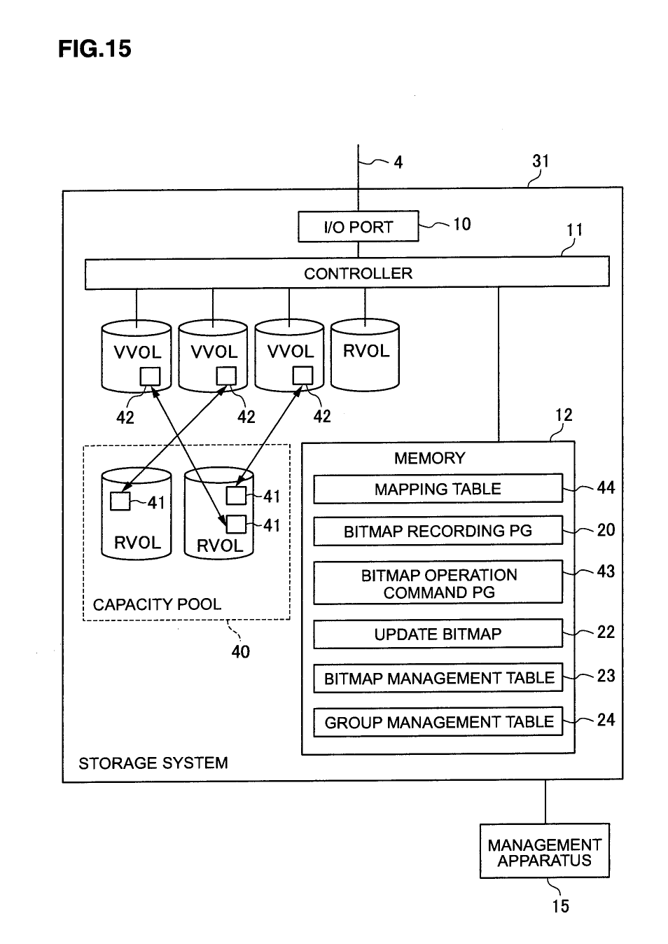

Here, as shown in FIG. 15, a dynamic capacity allocation function is a function of providing a virtual volume VVOL as a logical volume VOL to the host 2, and dynamically allocating a storage area to that virtual volume VVOL. The host 2 recognizes the virtual volume VVOL exactly the same way as a conventional real volume VOL, and issues write requests and read requests by designating the virtual volume VVOL.

When viewed from the host 2, it will seem that the virtual volume VVOL has the same capacity as the storage area storing the data exactly like the real volume RVOL, but in reality the virtual volume VVOL does not have a storage area for storing data.

If a write request is issued from the host 2 to the virtual volume VVOL, the controller 11 of the storage system 31 acquires the storage area 41 of the required capacity from the capacity pool 40, and stores data in the storage area 41. Thereafter, the storage area 41 is associated with the area 42 (this is hereinafter referred to as “mapping”) into which data in the virtual volume VVOL was written, and data is read from and written into the storage area 41 in the capacity pool 40 in accordance with the write request or read request from the host 2 that designated the area 42. As described above, with the virtual volume VVOL, the storage area 41 is mapped from the capacity pool 40 only to the area into which data from the host 2 was written.

Here, the capacity pool 40 refers to an aggregate of storage areas for storing data written into the virtual volume VVOL. In the following explanation, let it be assumed that the capacity pool 40 is configured from several real volumes RVOL. The real volumes RVOL configuring the capacity pool 40 are also defined in the storage area provided by the RAID group 14 (FIG. 2), and are highly reliable.

When writing data into the virtual volume VVOL, if the storage area 41 is not allocated to the area 42 of the write location, a suitable real volume RVOL is selected among the real volumes RVOL contained in the capacity pool 40, and a suitable storage area 41 in the real volume RVOL is also selected, and that storage area 41 is mapped to the area 42 in the virtual volume VVOL.

In order to simplify the management of this kind of virtual volume VVOL and the storage area of the logical volume VOL contained in the capacity pool 40, the dynamic capacity allocation function generally manages the areas in the virtual volume VVOL in area units having a prescribed size referred to as a chunk. The size of a chunk is generally set to approximately 10 MB, but needless to say that size may be set arbitrarily. All virtual volumes VVOL are managed as an aggregate of chunks. For example, a virtual volume VVOL of 100 GB is configured from 10,240 chunks.

However, since the storage area is not initially allocated from the capacity pool 40 to the virtual volume VVOL, a physical storage area is not allocated to the respective chunks of the virtual volume VVOL.

Meanwhile, all real volumes RVOL configuring the capacity pool 40 are managed by dividing the storage area 41 into storage areas having the same size as the chunk (these are hereinafter referred to as the “chunk size storage areas”). As described above, the processing of allocating the storage area from the capacity pool 40 to the virtual volume VVOL in reality is carried out by suitably selecting and mapping a sufficient number of chunk size storage areas for storing the write-target data from the capacity pool 40 to the chunks containing the write location of the data in that virtual volume VVOL. According to the foregoing method, the mapping of the storage area from the capacity pool 40 to the virtual volume VVOL can be realized as the allocation of the chunk size storage areas in the capacity pool 40 to the chunks in the virtual volume VVOL.

Incidentally, the total (apparent) capacity of all virtual volumes VVOL may be larger than the total storage capacity of the real volumes RVOL configuring the capacity pool 40.

As means for realizing the foregoing dynamic capacity allocation function, the storage system 31 of the present invention stores in its memory 12, as shown in FIG. 15, a mapping table 44 in addition to the bitmap recording program 20, the bitmap operation command program 43, the update bitmap 22, the bitmap management table 23 and the group management table 24.

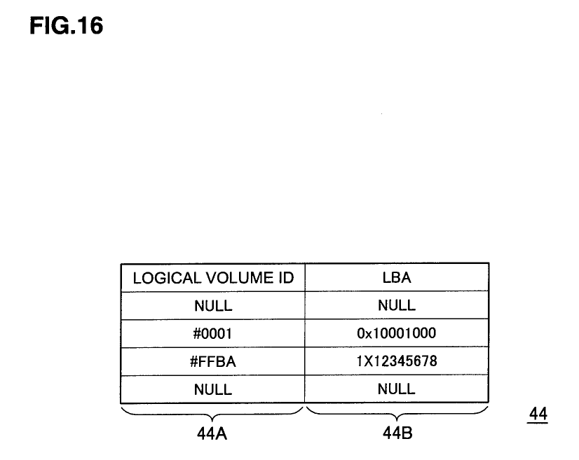

The mapping table 44 is a table for managing the allocation status of the chunk size storage areas in relation to the respective chunks of the virtual volume VVOL, and is created for each virtual volume VVOL. The mapping table 44 has, as shown in FIG. 16, a plurality of entries associated with the respective chunks of the corresponding virtual volume VVOL, and each entry is configured from a volume ID column 44A and an LBA column 44B.

The volume ID column 44A stores the volume ID of the real volumes RVOL in the capacity pool 40 providing the chunk size storage area allocated to the corresponding chunk in the corresponding virtual volume VVOL. The LBA column 44B stores the start address of that chunk size storage area (LBA of the top logical block of that chunk size storage area). Incidentally, among the entries of the mapping table 44, entries in which the logical volume ID is an invalid value (“NULL” for instance) show that a chunk size storage area has not yet been allocated to the corresponding chunk.

Accordingly, the mapping table 44 shown in FIG. 16 shows that the corresponding virtual volume VVOL is configured from four chunks, and the chunk size storage area has not yet been allocated to the first chunk (chunk having a chunk ID of “1”) and the fourth chunk (chunk having a chunk ID of “4”). In addition, it is understood that a chunk size storage area with a top LBA logical block of “LBA0x10001000” in the real volume RVOL assigned with a volume ID of “#0001” configuring the capacity pool 40 has been allocated to the second chunk (chunk having a chunk ID of “2”). Moreover, it is also understood that a chunk size storage area with a top LBA logical block of “LBA0x12345678” in the logical volume VOL assigned with a volume ID of “#FFBA” configuring the capacity pool 40 has been allocated to the third chunk (chunk having a chunk ID of “3”).

(2-2) Flow of Backup Processing in this Embodiment

The backup processing in the present embodiment is now explained. Since the backup processing in this embodiment is basically the same as the backup processing explained in the first embodiment, only the modifications are explained with reference to FIG. 6A and FIG. 6B.

With the backup processing according to the present embodiment, immediately after acquiring the snapshot SS of the logical volume VOL (real volume RVOL) to be backed up at step SP2 of FIG. 6A, a prescribed command (this is hereinafter referred to as the “allocation bitmap read command”) designating the virtual volume VVOL to be backed up is issued to the storage system 31 (FIG. 14) based on the backup software 33 (FIG. 14) loaded in the management host 32 (FIG. 14).

The controller 11 (FIG. 15) of the storage system 31 that received the allocation bitmap read command refers to the mapping table 44 (FIG. 15) of the virtual volume VVOL designated in the allocation bitmap read command, creates a bitmap (this is hereinafter referred to as the “allocation bitmap”) which sets the bit corresponding to the chunk to which the chunk size storage area in the virtual volume VVOL was allocated to ON, and sets a bit corresponding to the chunk to which the chunk size storage area in the virtual volume VVOL has not yet been allocated to OFF, and sends this allocation bitmap to the management host 32.

Here, the chunk size storage area not yet being allocated to the chunk of the virtual volume VVOL means that the host 2 has not yet written valid data into that chunk in the virtual volume VVOL. Accordingly, there is no need to back up that chunk in the virtual volume VVOL.

Thus, while the management host 32 acquires the full backup of the real volume RVOL to be backed up at step SP4 of FIG. 6A as with the first embodiment on the one hand, it refers to the allocation bitmap acquired at step SP2 based on the backup software 33 regarding the virtual volume VVOL to be backed up, and controls the storage system 31 to back up only the data stored in the chunks to which the chunk size storage area has been allocated rather than performing the full backup.

With the backup acquired in the foregoing case, as with the incremental backup, the location information of the portions that were backed up must be simultaneously recorded in the external media 6. Thus, the management host 32 may, for instance, record the allocation bitmap read from the storage system 31 at such time in the external media 6.

As described above, by additionally equipping the storage system 31 having a dynamic capacity allocation function with the foregoing allocation bitmap creation function and the transfer function for transferring the allocation bitmap to the management host 32, it will no longer be necessary to acquire the full backup at all, and additional reduction of capacity can be realized. Incidentally, the subsequent processing routine for creating the incremental/differential backup in FIG. 6A and FIG. 6B is the same as the first embodiment.

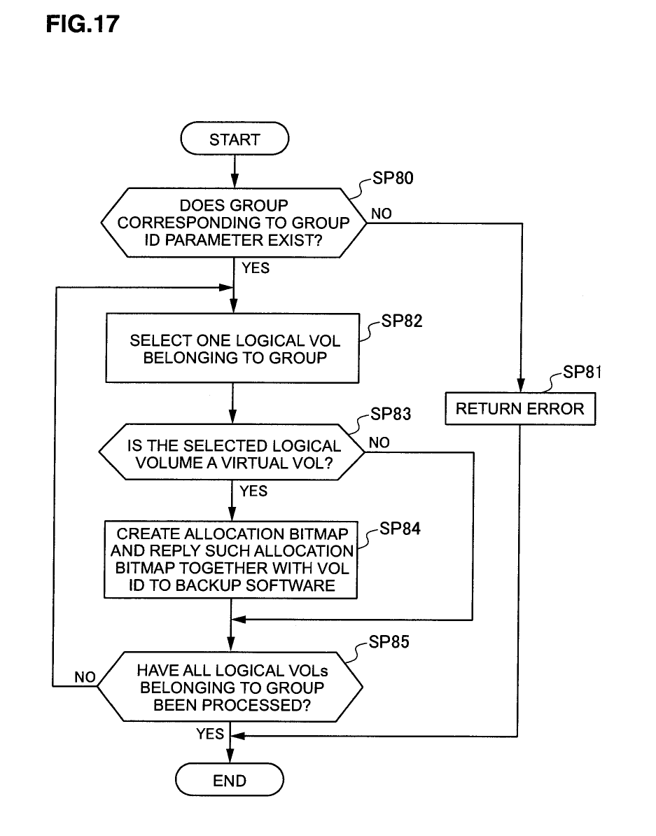

FIG. 17 shows the processing routine of the allocation bitmap read processing to be executed by the controller 11 at step SP21 of FIG. 8 if it is determined that the bitmap operation command from the management host 32 is an allocation bitmap read command at step SP20 of FIG. 8 (upon receiving the allocation bitmap read command issued by the management host 32 at step SP2 of FIG. 6A). The controller 11 executes this allocation bitmap read processing in accordance with the corresponding processing routine that was read by the bitmap operation command program 43 (FIG. 15).

Specifically, when the controller 11 receives the allocation bitmap read command it proceeds to step SP21 of FIG. 8 and starts this allocation bitmap read processing, and foremost refers to the group management table 24 (FIG. 5, FIG. 15) and determines whether a group of the group ID designated in the allocation bitmap read command exists (SP80).

If the controller 11 obtains a negative result in this determination, it returns an error to the bitmap operation command program 21 (FIG. 3) (SP81), and thereafter ends this allocation bitmap read processing.

Meanwhile, if the controller 11 obtains a positive result in the determination at step SP80, it refers to the group management table 24 and selects one logical volume VOL among the logical volumes VOL configuring the group of the group ID designated in the allocation bitmap read command (SP82), and determines whether the selected logical volume VOL is a virtual volume VVOL (SP83).

If the controller 11 obtains a negative result in this determination, it proceeds to step SP85. Meanwhile, if the controller 11 obtains a positive result in this determination, it refers to the mapping table 44 (FIG. 15) corresponding to that virtual volume VVOL, creates an allocation bitmap regarding that virtual volume VVOL, and sends the created allocation bitmap to the management host 32 (FIG. 14) (SP84).

Specifically, the controller 11 foremost allocates an unused area having the same size as the update bitmap 22 associated with that virtual volume VVOL in the memory 12, checks the entries of the mapping table 44 from the top, and, among the chunks in the virtual volume VVOL, sets a bit corresponding to the chunk to which a storage area (chunk size storage area) has been allocated from the capacity pool 40 to ON, and sets a bit corresponding to the chunk to which a storage area has not yet been allocated to OFF. The controller 11 sends the created allocation bitmap, together with the volume ID of the logical volume VOL selected at step SP82, to the management host 32.

Subsequently, the controller 11 determines whether similar processing has been executed regarding all logical volumes VOL belonging to the group of the group ID designated in the allocation bitmap read command (SP85). If the controller 11 obtains a negative result in this determination, it returns to step SP82 and thereafter repeats similar processing until a positive result is obtained at step SP85 (SP82 to SP85-SP82).

When the controller 11 eventually obtains a positive result at step SP85 upon completing the similar processing regarding all logical volumes VOL belonging to the group of the group ID designated in the allocation bitmap read command, it ends this allocation bitmap read processing.

(2-3) Effect of this Embodiment

With the computer system 30 according to the present embodiment described above, since only the data stored in the chunks to which the chunk size storage area has been allocated is backed up regarding the virtual volume VVOL to be backed up, it is possible to additionally reduce the backup capacity, increase the speed of backup, and thereby efficiently perform the backup process even with a storage system 31 equipped with the dynamic capacity allocation function.

### (2-4) Other Embodiments

Incidentally, in the second embodiment described above, although a case was explained where the storage system 31 having the dynamic capacity allocation function is equipped with both the first backup function of backing up the real volume RVOL based on the backup method of the first embodiment and the second backup function of backing up the virtual volume VVOL based on the backup method of this embodiment, the present invention is not limited thereto, and, for instance, the storage system 31 may also be loaded only with the second backup function. Even in the foregoing case, this will contribute considerably to the reduction in the backup capacity since it will no longer be necessary to perform the full backup of the virtual volume VVOL.

Moreover, in the second embodiment described above, although a case was explained where data stored in the chunk to which the chunk size storage area has not yet been allocated in the virtual volume VVOL is not backed up to the external media 6, the present invention is not limited thereto, and special data (all 0 for instance) and the like may also be written as backup data into the external media 6.

According to the foregoing method, although this will not contribute to the reduction of the backup capacity, it will be possible to increase the backup speed in comparison to the acquisition of the full backup since the reading of data from the virtual volume VVOL can be omitted due to the allocation bitmap. Moreover, since backup data in the same format as the full backup of the normal raw volume backup can be acquired as the backup data, there is an advantage in that special restoration processing giving consideration to the bitmap during restoration will no longer be required.

Further, in the second embodiment described above, although a case was explained where the backup of the virtual volume VOL is performed by transferring the allocation bitmap of the virtual volume VVOL to be backed up to the management host 32 and the management host 32 controlling the storage system 31 based on such allocation bitmap, the present invention is not limited thereto, and, for instance, as the command to be issued from the management host 32 to the storage system 31, a backup dedicated read command to be used at the time that the management host 32 reads the backup data may also be added.

In the foregoing case, the storage system 31 that received the read command sends the data stored in the chunk to which the chunk size storage area has been allocated in the virtual volume VVOL to the management host 32, and sends a reply representing that no allocation has been made regarding the chunks to which the chunk size storage area has not yet been allocated to the management host 32. According to this kind of backup method, the management host 32 will no longer have to read the allocation bitmap. In substitute for providing the foregoing backup dedicated read command, the management host 32 may also read data from the virtual volume VVOL based on a normal read command, confirm the read data, and detect special data (all 0 for instance) replied by the storage system 31 upon reading the chunks to which the chunk size storage area has not yet been allocated in the virtual volume VVOL so as to detect the chunks to which the chunk size storage area has not yet been allocated, and back up only the data stored in the chunks to which the chunk size storage area has been allocated.

### (3) Third Embodiment

(3-1) Configuration of Computer System in this Embodiment

According to the backup method of the first embodiment, among the storage areas in the logical volume VOL to be backed up, the storage areas in which the host 2 has not written data can be excluded from the backup target. Specifically, if the host 2 has not updated the logical volume VOL even once from the previous backup acquisition, data of that storage area is considered to be the same as the previous backup data.

However, this is not necessarily true in the opposite sense. Specifically, even if the host 2 has updated the logical volume VOL from the previous backup acquisition, data of the updated storage area is not necessarily different from the data of the previous backup data. As a typical example, a case may be considered where the application overwrites the same data. This kind of data will be backed up as a backup target according to the backup method of the first embodiment. Thus, if it is possible to exclude data that was updated during the period between the previous backup and the current backup but in which the updated data is exactly the same as the data before being updated from the backup target, it will be possible to additionally reduce the backup capacity.

In order to realize this kind of backup method, it is necessary to detect the consistency/inconsistency between the data stored in the logical volume VOL and the backup data in addition to the update status of the logical volume VOL. However, the method of comparing, point for point, the data read from the logical volume VOL and the corresponding data that has already been backed upon acquiring the backup will considerably lengthen the backup processing time and is not practical.

Thus, in the present embodiment, the consistency/inconsistency of the backup-target data stored in the logical volume VOL and the corresponding data that has already been backed up will be confirmed using a “hash function.”

Here, as the “hash function,” for instance, SHA-256 and the like are well known and are actually being used. The characteristic of this technology is that if data of an arbitrary length is input and an output of a fixed length is obtained (for instance, 256 bits), a different output (hash value of input data) can be obtained in relation to a different input. Needless to say, if data having a bit count that is greater than the output is used as the input, the percentage that the same hash value will be returned to a different input is not zero (this kind of phenomenon is referred to as a “hash collision”). However, by securing a sufficient bit count of the hash value (for instance, if 256 bits are allocated, a serial number can be assigned to all molecules on the planet), and sufficiently devising the hash function, a hash function that will not cause a collision in a practical sense can be developed, and the practical application thereof is as described above. Thus, in the present embodiment, this technology is employed for determining the consistency/inconsistency of backup data.

However, since the calculation of the hash function requires a certain amount of calculation time, even though less time is required in comparison to the case of comparing the actual data, if the hash function is calculated for all data, this will also considerably lengthen the backup processing time.

Thus, in the present embodiment, by concurrently using this technology with the technology described in the foregoing first embodiment and second embodiment, the reading of data and the calculation of hash value will not be executed for data that does not need to be backed up or data that is known to be the same data. The backup capacity can thereby be additionally reduced with a practical backup processing time. The backup processing of this embodiment is now explained with reference to FIG. 6A and FIG. 6B.

In the case of the computer system 50, 60 (FIG. 1 and FIG. 14) according to the present embodiment, foremost, at step SP4 of FIG. 6A, the management host 51, 61 calculates the hash value for each subsection shown with 1 bit of the update bitmap 22 based on the backup software 52, 62 upon acquiring the full backup from the snapshot SS to the external media 6, and records the calculation result, together with the full backup, in the external media 6.

In addition, when the management host 51, 61 uses the update bitmap 22 to acquire the incremental backup from the snapshot SS based on the backup software 52, 62 at step SP9, it calculates the hash value of the data read from the logical volume VOL, compares this with the hash value of the full backup, and, if the corresponding data in the full backup has the same hash value, it does not back up the data itself even if it is shown that the subsection has been updated in the update bitmap 22, and instead records referral information (pointer or the like) of the data having the same hash value in the full backup.

According to the foregoing method, even in cases where the application 7 of the host 2 overwrites the same data, it is possible to exclude such data from the backup target, and the backup capacity can thereby be reduced. In addition, by using the update bitmap 22, since it is no longer necessary to calculate the hash function for all data of the logical volume VOL, it is possible to inhibit the lengthening of the backup processing time.

(3-2) Effect of this Embodiment

In the present embodiment described above, since the consistency/inconsistency of backup-target data stored in the logical volume VOL and the corresponding data that has already been backed up is confirmed using the “hash function” so that, among the subsections in the logical volume VOL to be backed up, data in the subsections having consistent hash values is not backed up, it is possible to additionally reduce the backup capacity with a practical backup processing time.

### (3-3) Other Embodiments

Incidentally, in the third embodiment described above, although a case was explained where the management host 51, 61 performs the hash calculation, the present invention is not limited thereto, and the hash calculation may also be executed by the storage system 5, 31 (FIG. 1 and FIG. 14).

In the foregoing case, a backup dedicated read command is issued from the management host 51, 61 to the storage system 5, 31 for reading data during the backup. The storage system 5, 31 that received the read command merely needs to send the backup-target data, together with the hash value of such data, to the management host 51, 61. As a result of using this read command at step SP4 and step SP9 of FIG. 6A and FIG. 6B, the management host 51, 61 will no longer have to calculate the hash function, and it will be possible to additionally inhibit the lengthening of the backup processing time.

### INDUSTRIAL APPLICABILITY

The present invention can be broadly applied to computer systems of various configurations equipped with a backup function for backing up data written into a logical volume provided by a storage system.

1. A backup system for backing up data written by a host into a logical volume provided by a storage system, comprising:
an update location management unit for managing an update location in the logical volume updated by the host; and
a backup control unit for controlling the storage system to selectively back up the data written into the update location in the logical volume based on the management result of the update location management unit.

2. The backup system according to claim 1,
wherein the update location management unit includes a controller of the storage system;
wherein the backup control unit includes a management host connected to the storage system;
wherein the controller manages the update location by recording the update location from a prescribed point in the logical volume into a first bitmap; and
wherein the management host reads the first bitmap from the storage system and controls the storage system to selectively back up the data written into the update location in the logical volume based on the first bitmap that was read.

3. The backup system according to claim 1,
wherein the update location management unit manages an update location from the previous backup in the logical volume.

4. The backup system according to claim 1,
wherein the update location management unit manages an update location in the logical volume after acquiring a full backup of that logical volume.

5. The backup system according to claim 1,
wherein the logical volume includes a virtual volume to which a storage area is dynamically allocated according to its usage;
wherein the update location management unit manages an area in the virtual volume to which the storage area was allocated and creates a second bitmap representing an area in the virtual volume to which the storage area was allocated based on the management result; and
wherein the backup control unit reads the second bitmap from the storage system regarding the virtual volume and controls the storage system to selectively back up data written into an area in the virtual volume to which the storage area was allocated based on the second bitmap that was read.

6. The backup system according to claim 1,
wherein the backup control unit determines the consistency/inconsistency of data written into the update location in the logical volume and corresponding data that was previously backed up and controls the storage system to back up the data written into the logical volume when the data are inconsistent.

7. The backup system according to claim 6,
wherein the backup control unit determines the consistency/inconsistency of data written into the update location in the logical volume and corresponding data that was previously backed up based on the hash values of both data.

8. A backup method for backing up data written by a host into a logical volume provided by a storage system, comprising:
a first step of managing an update location in the logical volume updated by the host; and
a second step of controlling the storage system to selectively back up the data written into the update location in the logical volume based on the management result of the update location.

9. The backup method according to claim 8,
wherein, at the first step, the update location is managed by recording the update location from a prescribed point in the logical volume into a first bitmap; and
wherein, at the second step, the first bitmap is read from the storage system and the storage system is controlled to selectively back up the data written into the update location in the logical volume based on the first bitmap that was read.

10. The backup method according to claim 8,
wherein, at the first step, the update location from the previous backup in the logical volume is managed.

11. The backup method according to claim 8,
wherein, at the first step, an update location in the logical volume after acquiring a full backup of that logical volume is managed.

12. The backup method according to claim 8,
wherein the logical volume includes a virtual volume to which a storage area is dynamically allocated according to its usage;
wherein, at the first step, an area in the virtual volume to which the storage area was allocated is managed and a second bitmap representing an area in the virtual volume to which the storage area was allocated is created based on the management result; and
wherein, at the second step, the second bitmap is read from the storage system regarding the virtual volume and the storage system is controlled to selectively back up data written into an area in the virtual volume to which the storage area was allocated based on the second bitmap that was read.

13. The backup method according to claim 8,
wherein, at the second step, the consistency/inconsistency of data written into the update location in the logical volume and corresponding data that was previously backed up is determined and the storage system is controlled to back up the data written into the logical volume when the data are inconsistent.

14. The backup method according to claim 13,
wherein, at the second step, the consistency/inconsistency of data written into the update location in the logical volume and corresponding data that was previously backed up is determined based on the hash values of both data.
